(19) United States
(12) Patent Application Publication
(10) Pub. No.: US 2006/0051080 A1
(43) Pub. Date: Mar. 9, 2006

(54) Oilfield tool annulus heater

(76) Inventor: Michael Ray Carr, Minden, LA (US)

Correspondence Address: Michael Ray Carr, Sr., 324 E. Union, Minden, LA, 71055, US

(21) Appl. No.: 11/255,511

(22) Filed: Oct. 21, 2005

Related U.S. Application Data
(62) Division of application No. 10/614,580, filed on Dec. 9, 2003, now abandoned.
(60) Provisional application No. 60/397,723, filed on Jul. 22, 2002.

(51) Int. Cl. F24H 1/10; H05B 3/40

(52) U.S. Cl. 392/478

(57) ABSTRACT

An apparatus for heating fluids produced in an oil producing well anywhere in the annulus that fluid exists. By incorporating the heating apparatus (10) as a section or joint of the tubing or attached to the down hole pump or gas lift system. Heating apparatus comprising an inner hollow tube (11 and 28). A heat source (12), supplied with electrical current by a suitable source of electrical energy or steam source (30) which may be employed. Outer cases (19, 20 and 29) that enclose termination areas creating moisture proof chambers (31 ). Threaded couplings (26 and 27) attached to the apparatus to allow integration of the heating apparatus (10) to existing piping system or pumping system.

### CROSS-REFERENCE TO RELATED APPLICATIONS

Provisional Patent Application No. 60/397,723 filing date Jul. 22, 2002 confirmation number 1856 this is a division of Ser. No. 10/614580, Filed Jul. 07, 2003 .

### BACKGROUND

1. Field of Invention

This invention relates to providing a means and apparatus for delivering a permanent heat source anywhere in the annulus, where fluid is present, particularly in a drilled oil well.

2. Description of Prior Art

From the beginning of crude oil discovery and production one of the most expensive problems producers have encountered is the build up of paraffin and paraffin-like deposits in the annulus. Additionally paraffin deposits and asphaltean solidification at the perforations have made production of many well impossible or uneconomical. It is not uncommon that the ability to produce heavy hydrocarbons is completely stopped due to these deposits at the perforations. All prior art referred to below is directed towards heating the well bore or dissolving deposits after solidification occurs.

The need to provide a permanent heat source anywhere in the annulus is obvious. In some areas, wells decline in productivity, at a more or less rapid rate, because of the solidification of paraffin or asphalteans at the perforations of a well. In addition deposits in the annulus above the perforations result in added expense. When pulling the production tubing of a well deposits make pulling the tubing difficult, and in some cases of extreme deposits impossible.

Various techniques have been employed for the removal of paraffm and asphaltean deposits at the perforations. One such method is chemical treatments or solvents, to dissolve the deposits. The varying composition of crude oil from one zone to another, as well as one well to another, limited the effectiveness of solvents. The process of using solvents is expensive and experimental from one well to the next. In addition, it is treating an existing problem rather then preventing it.

Additionally, another method commonly used in the oil industry to treat paraffin deposits requires stopping production, the cost of a rig to retrieve the pump, lowering a heating apparatus into the well and heating the fluid at the perforations. This is done in an attempt to melt the deposits, which have already occurred at the perforations. The heating apparatus must then be retrieved, the pump reinserted and the well put back into production. The process is very time consuming, costly and has little success. The heater is capable of only temporarily heating the oil in the annulus, and once retrieved the heating effects end. Immediately the paraffin and asphaltean deposits begin to reoccur requiring repeated downtime and expense. Again the method is a treatment not prevention.

Prior arts referenced have also attempted a permanent heat source specifically for bottom hole application. Several flaws in previous designs have rendered these bottom hole heaters both limited in effectiveness and uneconomical. U.S. Pat. No. 2,808,110 to Spitz (1957) discloses an oil well heater as placed below the pump and has a small heater coil inside a partially perforated pot. This is submerged in the bottom of the production area and allows fluid to be heated and then pass thru a perforated section of tubing affixed between the heater and pump.

Spitz, by his admission is attempting to heat the oil sands by heating the water present in the oil-bearing formation. This is an attempt to heat the formation beyond the perforations. Spitz also states his apparatus is an attempt for removing paraffm and asphalt which has congealed and formed a block for the flow of oil. Here again the attempt is to treat paraffin and asphalt deposits after they have formed, not prevent them from occurring.

Sptiz and the Petrotherm Electric Bottom-Hole Heating System are both ineffective due to the effect they have on the pump referred to as gas lock. Both designs heated the fluid as if passed over the heat source directly to the pump. This design fails to allow the heated gas to be released into the annulus, and only the fluid to move through the pump resulting in gas lock.

Both Spitz and Petrotherm bottom hole heaters are limited to use and application below the pump and cannot, due to design, be placed in the annulus above the pump or perforations.

References cited: U.S. Pat. No. 47,410 to Fraser (1865), U.S. Pat. No. 231,287 to Digman et al (1880), U.S. Pat. No. 457,457 to Robison et al (1891), U.S. Pat. No.522,737 to Lucock (1894), U.S. Pat. No. 573,142 to Flanegin (1896), U.S. Pat. No.762,628 to Gardner (1904), U.S. Pat. No. 766,313 to Yoast (1904), U.S. Pat. No. 780,279 to Gardner (1905), U.S. Pat. No. 784,454 to Waring (1905), U.S. Pat. No. 884,424 to Seymour et al (1908), U.S. Pat. No. 972,308 to Williamson (1910), U.S. Pat. No. 1,082,971 to Pick (1913), U.S. Pat. No. 1,095,365 to Williamson (1914), U.S. Pat. No. 1,169,262 to Huff (1916), U.S. Pat. No. 1,232,736 to Truman el al (1920), U.S. Pat. No. 1,360,404 TO Hollister et al (1920), U.S. Pat. No. 1,368,404 to Loftus (1921), U.S. Pat. No. 1,383,670 to Stephens (1921), U.S. Pat. No. 1,426,407 to Pennington (1922), U.S. Pat. No. 1,450,658 to Warnick (1923), U.S. Pat. No. 1,457,690 to Brine (1923), U.S. Pat. No. 1,464,618 to Pershing (1923), U.S. Pat. No. 1,477,802 to Beck (1923), U.S. Pat. No. 1,504,208 to Brine (1924), U.S. Pat. No. 1,540,648 to Pershing (1925), U.S. Pat. No. 1,646,599 to Schaefer (1927), U.S. Pat. No. 1,672,200 to Buck (1928), U.S. Pat. No. 1,690,994 TO Powell (1928), U.S. Pat. No. 1,701,884 to Hogle (1929), U.S. Pat. No. 1,761,227 to Pasley (1930), U.S. Pat. No. 1,776,997 to Downey (1930), U.S. Pat. No. 1,839,632 to Agnew (1932), U.S. Pat. No. 2,202,034 to Thomas (1940), U.S. Pat. No. 2,208,087 to Somers (1940), U.S. Pat. No. 2,244,256 to Looman (1941), U.S. Pat. No. 2,260,916 to Rial (1941), U.S. Pat. No. 2,332,708 to Freeman (1943), U.S. Pat. No. 2,484,063 to Ackley (1949), U.S. Pat. No. 2,500,305 to Ackley (1950), U.S. Pat. No. 2,632,836 to Ackley (1953), U.S. Pat. No. 2,660,249 TO Jakosky (1953), U.S. Pat. No. 2,666,487 to Bowman (1954), U.S. Pat. No. 2,685,930 to Albaugh (1954), U.S. Pat. No. 2,808,110 to Spitz (1957), U.S. Pat. No. 2,836,248 to Covington (1958), U.S. Pat. No. 2,998,066 to Nixon, Sr. (1961), U.S. Pat. No. 3,163,745 to Boston (1964), U.S. Pat. No. 3,279,541 to Know et al (1966), U.S. Pat. No. 3,410,347 to Triplett et al (1968), U.S. Pat. No. 3,437,146 toEverhart et al (1969), U.S. Pat. No. 3,614,986 to Gill (1971), U.S. Pat. No. 3,828,161 to Yamaguchi (1974), U.S. Pat. No. 3,943,330 to Pollock et al (1976), U.S. Pat. No. 4,026,358 to Allen (1977), U.S. Pat. No. 4,178,993 to Richardson et al (1979), U.S. Pat. No. 4,219,083 to Richardson et al (1980), U.S. Pat. No. 4,285,401 to Erickson (1981), U.S. Pat. No. 4,330,037 to Richardson et al (1982), U.S. Pat. No. 4,399,868 to Richardson et al (1983), U.S. Pat. No. 4,790,375 to Bridges (1988), U.S. Pat. No. 4,911,239 to Winckler et al (1990), U.S. Pat. No. 5,120,935 to Nenninger (1 992), U.S. Pat. No. 5,247,994 to Nenninger (1993), U.S. Pat. No. 5,282,263 to Nenninger (1994), U.S. Pat. No. 5,440,430 to Nenninger (1995).

Foreign Patent Documents: 1,182,392 CA. (1985), 2,504,187 to FR> (1982), 1,298,354 to SU. (1987), 8,810,356 to WO. (1988).

### OTHER REFERENCES

Nenninger et al, “Optimizing Hot Oiling/Watering Jobs to Minimize Formation Damage”, Petro. Society of CIM/Soc. Of Petro Eng, 1990
Nelson et al, “Oil Recovery By Thermal Methods”, Pt. 11, The Petroleum Engineer, February 1959
“High Temperature Thermal Techniques for Stimulating Oil Recovery”, P. D. White et al, J. of Petro. Technology, pp. 1007-1011, September 1965.
R. Van A. Mills The Paraffin Problem in Oil Wells, December 1923.
John Power Removing Paraffin Deposits from Wells with Electric Heater 1928.
L. G. E. Bignell Electric Heaters Remove Paraffin Nov. 14, 1929
Frank V. Eaton Applications of Heat Increases Production in Wyoming Field Apr. 22, 1943.
H. E. Allen and R. K. Davis “Electric Formation Heaters and Their Application” April 1954.
K. G. Parrent “Bottom Hole Heaters” May 1970.
World Oil “AC Current Heats Heavy Oil for Extra Recovery” May 1970.
Dr. S. M. Faroug Ali “Well Stimulations by Downhole Thermal Methods” October 1973
D. L. Currans “Electroflood Proves Technically Feasible” January 1980.
Edward T. Yukl & Andrew W. Marr, Jr. “Process Solves Paraffin Buildup in Tubing” Aug. 8, 1988.
Petrotherm Electric Bottom-Hole Heating System.

All of these methods have had minimal success. Paraffin and asphaltean solidification at the perforations are still a serious problem in the industry, with currently no heat source being successfully marketed in the industry. Additionally there is no heater designed for use in the upper annulus above the pump. First, all efforts have been to dissolve deposits after they occur. Secondly, the amount of heat supplied by previous designs has been insufficient. Thirdly, the designs either limited the use by having to stop production to temporarily introduce the heating apparatus, or, in the case of Spitz and Petrotherm resulted in loss of production due to the pump becoming gas locked. Fourth, no prior art has addressed the need for an annulus heater, only a bottom hole application.

### SUMMARY

The present invention will revolutionize the oil production industry. It is the first annulus heating apparatus ever introduced to the industry. In addition it is versatile enough to be introduced to be used below the pump, or be integrated as a section of the tubing anywhere heat is needed in the annulus. The ability to provide precise placement of the invention permanently anywhere the annulus fluid needs to be heated allows the producer to provide a heat source directly where the paraffin or paraffin-like deposits occur. The invention allows the producer to prevent such deposits. Additionally, the ability to heat the annulus fluids lowers the viscosity of the fluid. This in turn lowers the hydrostatic pressure allowing the bottom hole to produce more fluid. The ability to place the heater below the pump eliminates paraffin and asphaltean solidification at the perforations. The ability to heat the fluid also allows heavy hydrocarbons to be produced. The placement of the invention anywhere in the upper annulus heats the fluid in the annulus, in turn heating the tubing and minimizing deposits in the tubing strand. The design of the invention also prevents gas lock from occurring by heating the fluid in the annulus before it enters the pump or tubing. The continuously heated fluid also keeps the balls and seats in the down hole pump clear of deposits.

### OBJECTS AND ADVANTAGES

Accordingly, several objects and advantages of my invention are:
(a) to provide a heat source directly in the annulus at any point where fluid is present and paraffm begins to solidify
(b) to provide a heat source at the producing zone to prevent paraffin or asphaltean solidification
(c) the invention is not restricted to bottom hole or production zone application
(d) provide a heat source to the annulus in both flowing, pumping and gas lift wells, as normal pumping methods can be used through the invention
(e) prevents interference with the down hole pump due to gas lock from heated gas
(f) greatly reduces the need for hot oil services
(g) greatly reduces the need for chemical treatment of the production fluid
(h) eliminates the need to pull the well for the purpose of cleaning paraffin solidification in the annulus
(i) provides for continuously clear perforations, thus improving production and reducing loss of production for remediation methods
(j) provides for continuously clean pump and annulus
(k) lowers the viscosity of heavy hydrocarbon, thus lowers the hydrostatic pressure allowing for increased production

In accordance with the flexibility of my invention, direct application of heat where it is needed is allowed. This provides producers of crude oil the ability to produce wells more cost effectively. In addition the invention allows producers to successfully produce heavy crude's that are presently unproducable. Lowering the viscosity of the oil with a permanent and precise heat source where needed allows for a higher volume of production fluid to flow. Further objects and advantages of my invention will become apparent from a consideration of the drawings and ensuing description.

### DRAWING FIGURES

FIG. 1 shows annulus heating apparatus, with broken views for enclosed chambers.

FIG. 2 shows a view in section of a portion of the roof strata, showing the apparatus installed as a section of the production tubing and below the pump in an oil well.

### REFERENCE NUMERALS IN DRAWINGS

| | |
|---|---|
| 10 annulus heating apparatus | 11 inner tube |
| 12 heat source | 13 conduits for supply lines |
| 14 openings for feed-thru | 15 baffles |
| 16 conduits | 17 electrical terminations |
| 18 coupling | 19 outer case (upper) |
| 20 outer case (lower) | 21 rod |
| 22 washer | 23 washer |
| 24 washer | 25 washer |
| 26 threaded end | 27 threaded end |
| 28 lower inner tube | 29 outer case (mid-section) |
| 30 supply source line | 31 moisture proof chamber(s) |
| 32 supply source junction box | 33 down hole pump |

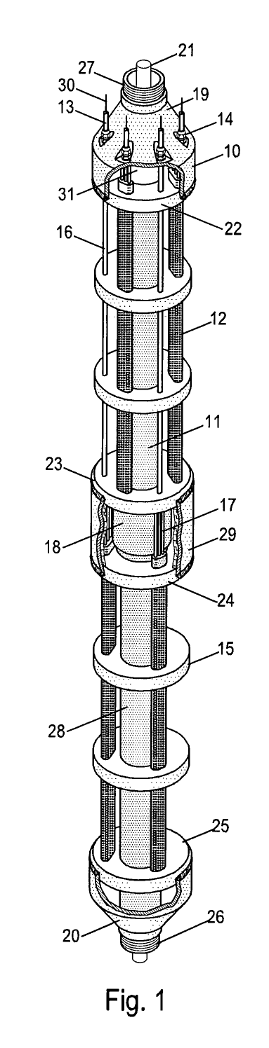

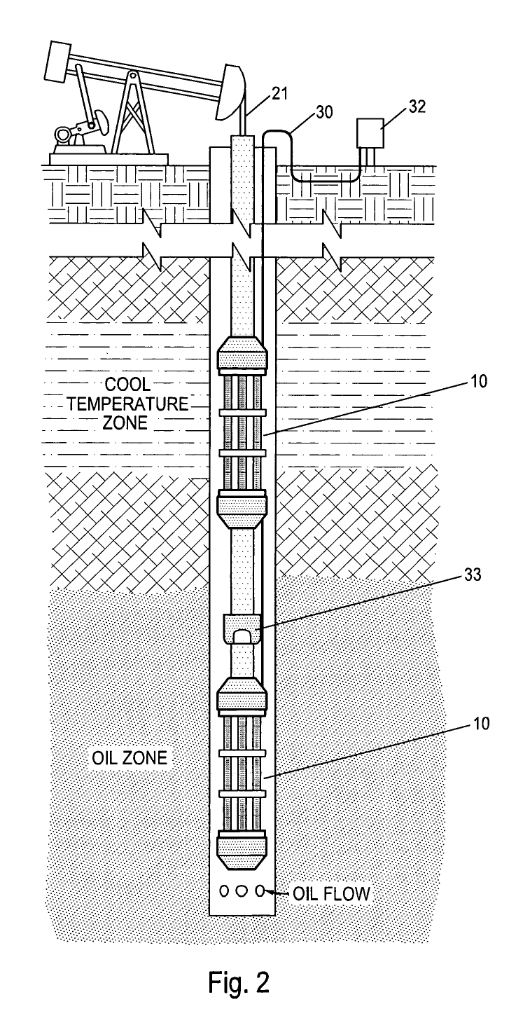

### DESCRIPTION—FIGS. 1 AND 2 PREFERRED EMBODIMENT

Referring to the embodiment shown in FIG. 1 and FIG. 2, like numerals indicate like parts throughout the two views. My heating apparatus 10 comprises an inner hollow cylindrical tube(s) 11 and 28. Tube 11 is of predetermined dimensions, threaded 27 at each end. Tube 11 in combination with threaded couplings 18 comprise a continuous inner core of predetermined dimensions. Couplings 18 and tube 11 and 28 are of suitable material and specifications to allow my heating apparatus 10 to be integrated into the production tubing or attached below the set nipple of the down hole pump in the oil production industry.

Suitable closure members 22, 23,24 and 25, resembling large washers, are attached by welding or other appropriate means at predetermined intervals along tube 11 and 28. Washers 22, 23, 24 and 25 having a plurality of holes as needed to allow for heat source 12 terminations and electrical or steam supply access. As indicated in FIG. 1 of the drawings the heat source 12 terminations or leads 17 pass through suitable openings in washer 22 and are sealed by appropriate means. In this connection all electrical wiring and connections are to be flash ignition proof and properly insulated. Washer 22 is attached to tube 11 at a predetermined spacing from threaded end 27, and allows and comprises suitable openings which allow for conduits 13, compatible with electrical or steam energy source 12 to be installed and sealed.

In the preferred embodiment baffle(s) 15 are placed at predetermined intervals to tube 11 and 28 and appropriately secured. Baffles(s) 15 support and space heat source 12 along tube 11 and 28.

Near the lower end of tube 11, washer 23 is placed at a predetermined interval from threaded end (not shown) and appropriately secured by welding or other means. Washer 23 allows and comprises suitable openings, which allow for conduits 13 and heat source 12 to pass through and are sealed by appropriate means.

Between washer 23 and 24 a suitable source of electrical or steam energy 30, which may be employed for the supply of electrical current or steam, to the heat source 12 are connected to the leads or terminations 17 of heat source 12. In this connection all electrical wiring and connections are to be flash ignition proof and properly insulated. Coupling, 18 connects tube 11 and 28.

As indicated in FIG. 1 the heat source 12 terminations and leads pass through suitable openings in washers 24 and 25 and are sealed by appropriate means. Washer 24 is attached to tube 28 at predetermined interval from upper threaded end (not shown) and appropriately secured. Washer 25 is attached at a predetermined distance from threaded end 26 and appropriately secured to tube 28.

Outer cases 19, 20 and 29 are of a material appropriate for use in the oil industry. Outer case 19 is secured by welding or other suitable means and sealed to tube 11 and washer 22 forming a sealed chamber(s) 31.

Outer case 19 is tapered and comprises a plurality of openings 14 of predetermined size allowing passage of any suitable electrical or steam energy source 30. Opening(s) 14 or sealed by welding, seal glands or other appropriate means creating moisture proof chamber(s) 31.

Outer case 20 is secured by welding or other suitable means to tube 28 and washer 25 forming sealed chamber(s) 31. Outer case 20 is configured in a tapered manner.

Outer case 29 is secured to washers 23 and 24 by welding or other appropriate means forming a moisture proof chamber(s) 31.

Sealed chamber(s) 31 are moisture proof chamber(s) encapsulating the terminal were the heat source 12 and energy supply source 30 connect.

In FIG. 2 heating apparatus 10 is incorporated into the production tubing at a predetermined location either bottom hole (below the pump 33), or in the upper annulus where fluid is constant. The sucker rod 21 passes through the heating apparatus. The electrical or steam supply line 30 is attached to heating apparatus 10 and the main supply source above ground 32.

### ADVANTAGES

From the description above, a number of advantages of my heating apparatus become evident:
(a) constant heat can be supplied to the annulus fluid without interruption of production
(b) heating apparatus can be incorporated anywhere in the production tubing, where the fluid level is constant in the annulus, as is needed
(c) heating apparatus can be incorporated below the pump to supply a permanent heat source to the annulus bottom hole
(d) production by means of pumping jack or gas lift system con operate normally with the heating apparatus in place
(e) down time for maintenance of well due to paraffin or asphaltean deposits in the annulus is reduced to minimal
(f) use of chemicals to treat deposits is reduced to minimal
(g) use of heating apparatus lowers the viscosity of heavy crude allowing for production of heavy hydrocarbons currently unproducable
(h) use of heating apparatus results in continuously clean perforations by preventing deposition of paraffin and asphalteans
(i) allows for maximum production by eliminating clogging of perforations, and lowering the viscosity of heavy hydrocarbons, lowering the hydrostatic pressure, allowing increased production
(j) heating the annulus fluids results in continuously clean pump
(k) heat applied to the annulus fluids aids in heating the tubing strand and minimizing paraffin deposits in the tubing

### OPERATION—FIG. 1 AND 2

It may now be appreciated how my heating apparatus 10 may be employed. Prior to employing the preferred method of preventing the solidification of paraffin, paraffin-like and asphaltean deposits in the annulus, all prior attempts were to heat the well bore or treat deposits after they occurred. By incorporating my heating apparatus 10 into the annulus, either above or below the pump, deposits will not occur.

The manner of using the in line annulus heating apparatus in the production tubing is to determine if heat is needed bottom hole, below the pump at the perforations, or above the pump were annulus fluid shows paraffin or paraffin-like deposits. Pull the existing tubing strand, rods 21 and pump 33, by usual means practiced in the oil industry. When returning the tubing strand, rods 21 and pump 33 to the production hole, my annulus heating apparatus 10 should be place either below the pump or replace a joint of tubing, for upper installation, were paraffin deposits were noted in the annulus. My heating apparatus is designed in such a manner as to allow normal integration into the tubing strand by means of the threaded ends 26 and 27 located at each end of the apparatus.

The electrical or steam supply source 30 is connected to the heating apparatus 10 before it is lowered in to the production hole, and the line is fed into the well as the tubing and annulus heating apparatus 10 are replaced. The electrical or steam supply source 30 is periodically secured to the tubing stand in a manner, which is practiced in the petroleum industry.

When the tubing strand has been fully restored, the electrical or steam supply source 30 is connected to a switchbox or steam supply pump 32 located on the surface.

Normal production of the well resumes, either flowing or pumping. The popular means of pumping by use of a pumping jack, sucker rods 21 and down hole pump 33 can be employed with my preferred embodiment.

The oil well is put back into operation by pumping or flowing. When the heating apparatus is positioned below the pump, at the perforations, the heating apparatus raises the temperature of fluid to such a degree as is needed to keep all paraffm and asphalteans suspended in the oil, eliminating deposits at the perforations. As the fluid moves out of the producing zone, over the heating apparatus and then to the pump, the heated fluid prevents deposits form occurring within the pump. The heated fluid below the pump also serves to lower the viscosity of heavy hydrocarbons making the fluid more producable

When the heating apparatus is positioned above the pump, the fluid in the annulus is heated. This placement serves a variety of purposes. First, the heated fluid prevents deposits from occurring in the upper annulus. Secondly, the heat lowers the viscosity of the fluid, lowering the hydrostatic pressure, allowing more fluid to be produced. Thirdly, the heated annulus fluid heats the tubing strand, reducing the accumulation of paraffin deposits in the tubing.

### CONCLUSION, RAMIFICATIONS AND SCOPE

Accordingly, the reader will appreciate that raising fluid temperature to a point where solidification of paraffin and asphalteans does not occur will keep perforations open allowing for continuous production. Heating the annulus fluids above the pump prevent paraffin deposits that result in the production tubing strand to become lodged in the well. In addition heating of the annulus fluids lowers the viscosity of the fluids, lowering the hydrostatic pressure and allowing more fluid, particularly in the case of heavy hydrocarbons, to be produced. My heating apparatus- provides the heat source were it is needed with a constant heat while production occurs.

Furthermore, the heating apparatus offers additional advantages in that:
It permits the heating apparatus to be installed during regular
maintenance of the well, eliminating the expense of pulling the well exclusively to install the apparatus.
It allows the well to be produced without the expense of treatment chemicals
It provides a way to produce the well without the downtime and expense of hot oil services.
It prevents the risk of paraffin, paraffm-like and asphaltean deposits form ever forming at the perforations.
It prevents the risk of paraffin and paraffin-like deposits form occurring in the upper annulus.
Allows production of heavy hydrocarbons by heating the production fluid, this lowering the viscosity of the fluid. This allows for more freely flowing fluid out of the producing zone by lowering the hydrostatic pressure and thinning the fluid.
Reduces risk of loss of production associated with down time to clean or treat deposits.
It provides a cost effective means to lighten heavy crude and make it producable.

Although the description above contains many specifications, these should not be construed as limiting the scope of the invention, but as merely providing illustrations of some of the presently preferred embodiments of this invention. Various modifications will be apparent to and can be readily made by those skilled in the art to which the invention pertains without departing from the spirit and scope of the invention.

Accordingly, the scope of the invention and its method should be determined not by the embodiment(s) illustrated, but by the appended claims and their equivalents.

I claim:

1. A system for heating a substance found in the annulus of an oil producing well: a heating system interposed in the production tubing between a first point and second point, is such that the substance in the annulus between the first and second point is directly heated.

2. An apparatus to be located in the annulus, interposed in the production tubing comprising: a heating system having couplings compatible with each end of the production tubing to which it is to be attached; at least one heating element open to the annulus fluid, such that the element directly heats the annulus fluid to a temperature sufficient to prevent the solidification of paraffin or paraffin-like substances.

3. A heating apparatus for heating the annulus fluids of an oil producing well: a heating system interposed in the production tubing between a first point and a second point, is such that the substance in the annulus between the first and second point is heated, lowering the viscosity of the substance thus lowering the hydrostatic pressure of the substance.

4. A system for heating a substance in the annulus: a heating system comprising a tube with an inlet affixed to a pumping system conveying a substance from the producing zone of an oil producing well, to the surface, heating system comprising at least one heating element directly heating the substance.

5. A heating apparatus for heating the annulus fluids below the pump of an oil producing well comprising: a heating system having couplings which are compatible with the seat nipple of a down hole pump, or gas lift pump, to which it is to be attached; al least one heating element open to the annulus fluid, such that the element directly heats the annulus fluid to a temperature sufficient to prevent the solidification of paraffin, paraffin-like or asphaltean deposits at the perforations of the well.

6. A heating apparatus for heating the annulus fluids of an oil producing well comprising: a heating system having couplings compatible with the seat nipple of a down hole pump, or gas lift pump, to which it is to be attached; at least one heating element open to the annulus fluid, such that the element directly heats the annulus fluid to a temperature that lowers the viscosity of the fluid, thus lowering the hydrostatic pressure of the fluid, allowing more fluid to be produced.

7. The system of claim 1 having a plurality of heating elements.

8. The system of claim 4 having a plurality of heating elements.
